(19) United States
(12) Patent Application Publication
(10) Pub. No.: US 2005/0203969 A1
(43) Pub. Date: Sep. 15, 2005

(54) Version management system and version management method for content delivery and management

(75) Inventor: Kazuhiro Kawabe, Saitama (JP)

Correspondence Address: VENABLE LLP, P.O. BOX 34385, WASHINGTON, DC, 20045-9998, US

(73) Assignee: Oki Electric Industry Co., Ltd., Tokyo (JP)

(21) Appl. No.: 11/070,254

(22) Filed: Mar. 3, 2005

(30) Foreign Application Priority Data
Mar. 15, 2004 (JP) 2004-073230

(51) Int. Cl. G06F 12/00

(52) U.S. Cl. 707/203

(57) ABSTRACT

A version management system and method, enabling discarding of old version content files through simple and low-load processing. Storage periods and holding periods are allocated to a plurality of storage elements provided in a non-newest file storage unit. When a newest version content file is registered, the content file is stored in a newest version file storage unit. A content file which has become a non-newest version content file due to the version upgrade is transferred from the newest version file storage unit to be stored in the storage element to which is allocated the storage period corresponding to the date of the version upgrade. When the above corresponding holding period has elapsed, content files within the storage element are all simultaneously deleted.

### BACKGROUND OF THE INVENTION

1. Field of the Invention

The present invention relates to versioning technology, that is, technology for managing the history of version revisions of content. The present invention can be employed, for example, in content delivery and management systems loaded into a network server.

2. Description of Related Art

A content delivery and management system is a system for the management and delivery of content (for example, documents, Web content, rich media, and similar) registered by users. A content delivery and management system can update the version of content according to the intentions of users. In addition, typical content delivery and management systems can use version management tools to manage the version revision history of content. By using a version management tool, a content delivery and management system can distribute not only the latest version of content, but can distribute the older version of content prior to revision. In other words, a content delivery and management system comprises functions for storing and managing content, and functions for managing the revision history of content which is being stored and managed. By this means, users can distribute the desired version of content.

Well-known content delivery and management systems include, for example, IBM Content Manager and SilverStream ePortal. Well-known version management tools include Concurrent Versions System (CVS) and IBM Rational ClearCase. Among version control technologies are the dynamic and limited versioning proposed by Ming-Syan Chen et al (U.S. Pat. No. 5,287,496). This versioning can protect and manage physical pages considering simultaneous accesses.

Conventional content delivery and management systems have stored all registered content files, and have recorded the corresponding revision history without limits. However, if all content files are stored without further action, a vast quantity of storage capacity becomes necessary. Hence conventional content delivery and management systems have adopted a method of storing and managing only data differing from the initial content for all content other than the first registered content (that is, the oldest version of the content). By means of this method, the size of the second and subsequent versions of content files can be reduced, and so the amount of capacity required for storage can be decreased.

However, the content stored and managed in a content delivery and management system differs from a system for management of source programs under development and similar in that extremely old content, last revised several years previously, is expected to hardly ever be used. Hence it is desirable that, by discarding content files of extremely old versions, the capacity required for storage be further reduced.

### SUMMARY OF THE INVENTION

An object of the present invention is to provide version management technology enabling discarding of old-version content files through simple, low-load processing.

A version management system of the present invention has a newest file storage unit, which stores content files of the newest version; a non-newest file storage unit, having a plurality of storage elements each of which receive and store content files which are no longer the newest version due to a version upgrade; and a controller, which allocates a storage period and a holding period for each storage element, which transfers and stores content files which are no longer the newest version due to a version upgrade in a storage element to which has been allocated the storage period corresponding to the version upgrade date, and which deletes all content files in a storage element at the time at which the corresponding holding period has elapsed.

A version control method of the present invention comprises a step of allocating, to each of a plurality of storage elements provided in a non-newest file storage unit, a storage period and a holding period; a step of storing content files of the newest version in a newest file storage unit; a step of transferring and storing content files which have become non-newest version due to a version upgrade from the newest version file storage unit to a storage element to which has been allocated the storage period corresponding to the version upgrade date; and a step of deleting all content files in a storage element at the time at which the corresponding holding period has elapsed.

The version management system and method of the present invention allocating storage periods and holding periods to each storage element in advance, store content files which are no longer the newest files due to a version upgrade in a storage element to which has been allocated to the storage period corresponding to the version upgrade date, and delete all the content files within a storage element at the time at which the holding period for the storage element has elapsed. That is, processing to discard old content files is performed simply through batch deletion of information within storage elements. Hence the system and method of the present invention enable discarding of old content files merely through extremely simple, low-load processing.

### BRIEF DESCRIPTION OF THE DRAWINGS

Other objects and advantages of the invention are explained below, referring to the attached drawings.

FIG. 1 is a block diagram showing in summary the configuration of a network system of a preferred embodiment related to the present invention;

FIG. 2 is a block diagram showing in summary the internal configuration of the content management unit and history management unit shown in FIG. 1;

FIG. 3 is a flowchart used to explain the operation of registering new content in a version management tool shown in FIG. 1;

FIG. 4 is a conceptual diagram used to explain the operation of registering new content in a version management tool;

FIG. 5 is a flowchart used to explain the operation of version upgrade of content registered in a version management tool;

FIG. 6 and FIG. 7 are conceptual diagrams used to explain the operation of version upgrade of content registered in a version management tool;

FIG. 8 is a flowchart used to explain the operation of discarding content files the holding period of which has ended from a version management tool;

FIG. 9 is a conceptual diagram used to explain the operation of discarding content files the holding period of which has ended from a version management tool;

FIG. 10 is a flowchart used to explain the operation of viewing by a user of non-newest version content files;

FIG. 11 is a conceptual diagram used to explain the operation of viewing by a user of non-newest version content files;

FIG. 12 is a flowchart used to explain the operation of deletion by a user of content files; and,

FIG. 13 and FIG. 14 are conceptual diagrams used to explain the operation of deletion by a user of content files.

### DESCRIPTION OF THE PREFERRED EMBODIMENTS

Below, a preferred embodiment of the present invention are explained using the drawings. In the drawings, the sizes, shapes, and positional relations of constituent components are shown only schematically to a degree enabling understanding of the invention; moreover, numerical conditions described below are no more than examples.

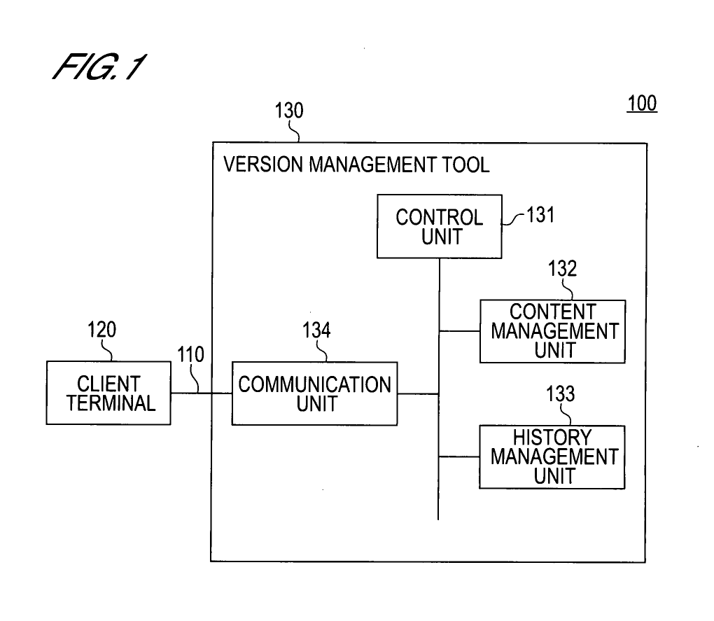

FIG. 1 is a block diagram showing in summary the configuration of a network system related to the present embodiment. As shown in FIG. 1, the system 100 comprises a network 110, a client terminal 120, and a version management tool 130 which corresponds to the version management system of the present invention.

The network 110 is for example a dedicated network, public network, mobile communication network, or a network which integrates all of these. The network 110 enables the client terminal 120 and the version management tool 130 to be connected and communicate.

The client terminal 120 is a terminal used by the user to perform operations on the version management tool 130. As the client terminal 120, for example, a personal computer may be used. The user can use the client terminal 120 to register his own content, make revisions, delete files, view content, and similar.

The version management tool 130 is a device for management of content registered by a user. The version management tool 130 can for example be constructed within a content delivery and management system provided in a server computer. As is explained below, when there is a content version upgrade, the version management tool 130 of the present embodiment discards old-version content after a prescribed period has elapsed. By this means, the version management tool 130 can reduce the storage capacity necessary to store contents and revision history information. In the present embodiment, an example is explained of a case in which a hardware-based version management tool 130 is constructed within the server computer of the content delivery and management system 100; but a software-based version management tool 130 can also be constructed within the server computer.

As shown in FIG. 1, the version management tool 130 comprises a control unit 131, content management unit 132, history management unit 133, and communication unit 134.

The control unit 131 executes the functions of the version management tool 130. For example, the control unit 131 registers new files, updates and deletes registered files, enables viewing of newest-version files and of old-version files, and manages file holding periods.

The content management unit 132 saves content files received from the client terminal 120. The content management unit 132 stores newest-version content files, and holds old-version content files for a fixed period after registration of newest-version content files.

The history management unit 133 stores the revision history of content files stored in the content management unit 132. The history management unit 133 also reads the specified version of specified content from the content management unit 132, based on control by the control unit 131.

The communication unit 134 performs communication between the client terminal 120 and each of the units 131 to 133.

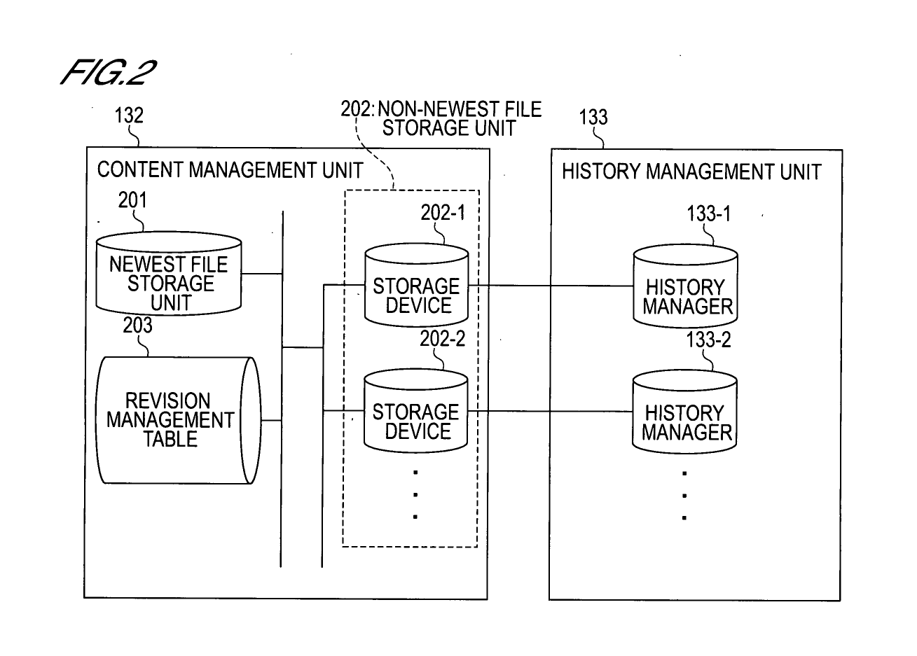

FIG. 2 is a block diagram showing in summary the internal configuration of the content management unit 132 and history management unit 133.

As shown in FIG. 2, a newest file storage unit 201, a non-newest file storage unit 202 and a revision management table 203 are comprised as subunits of the content management unit 132. These storage units 201, 202 and the table 203 may be configured in separate independent devices, or may be configured by dividing the storage area of a single storage device.

The newest file storage unit 201 stores newest-version content files, by content. When new content is registered in the version management tool 130, the content file is stored in the newest file storage unit 201. When previously registered content undergoes a version upgrade, the content file being stored in the newest file storage unit 201 is transferred to the non-newest file storage unit 202, and new content file is written to the newest file storage unit 201 instead of the transferred content file.

The non-newest file storage unit 202 stores content files other than newest-version files. The non-newest file storage unit 202 of the present embodiment comprises a plurality of storage elements. Each of the storage elements for example comprises either an individual storage device, or a storage area obtained by dividing the storage area of one or a plurality of storage devices. In the example of FIG. 2, the non-newest file storage unit 202 comprises the plurality of storage devices 202-1, 202-2, . . . , each of which constitutes single storage element. The storage device in which a content file transferred from the newest file storage unit 201 is to be stored is determined according to the date upon which the content underwent the version upgrade. For example, content files which are no longer the newest files due to a version upgrade performed in January may be stored in storage device 202-1, and content files which are no longer the newest files due to a version upgrade performed in February may be stored in storage device 202-2, and in similar manner the storage device in which non-newest content files are to be stored can be determined. As described below, each of the storage device 202-1, 202-2, . . . deletes the content files stored in its own, after a prescribed holding period has elapsed. Individual holding periods are set to the storage devices. As one example, a case is considered in which the non-newest file storage unit 202 has two storage devices 202-1 and 202-2, and the storage device 202-1 stores content files which have become non-newest files due to version upgrades in January, March, May, July, September, or November. In this case, the content files stored in the storage device 202-1 are all deleted at the end of February, and are used to save content files which have become non-newest files due to revisions in March. That is, the content files which had become non-newest files due to version upgrades between January 1 and January 31 are all deleted at the end of the last day in February. Hence when the storage periods corresponding to the two storage devices 202-1 and 202-2 are each one month, the holding periods for non-newest content files are, at the shortest, one month, and at the longest two months.

The revision management table 203 manages the file names, version numbers, and storage device identification numbers of content files stored in the non-newest file storage unit 202. The revision history information stored in the history management unit 133 can be substituted for the management information stored in the revision management table 203. When substituting the revision history information of the history management unit 133 for the management information stored in the revision management table 203, the revision management table 203 is unnecessary.

As shown in FIG. 2, the history management unit 133 comprises history managers 133-1, 133-2, . . . in the same number as the storage devices 202-1, 202-2, . . . . Each of the history managers 133-1, 133-2, . . . stores and manages history information relating to each of the content files stored in the corresponding storage device 202-1, 202-2, . . . . In the example of FIG. 2, history managers are provided for each storage device; however, a single history manager may for example store and manage the history of all content files stored in all the storage devices 2202-1, 202-2, . . . .

Next, operation of the system 100 shown in FIG. 1 and FIG. 2 is explained.

Registration of New Content

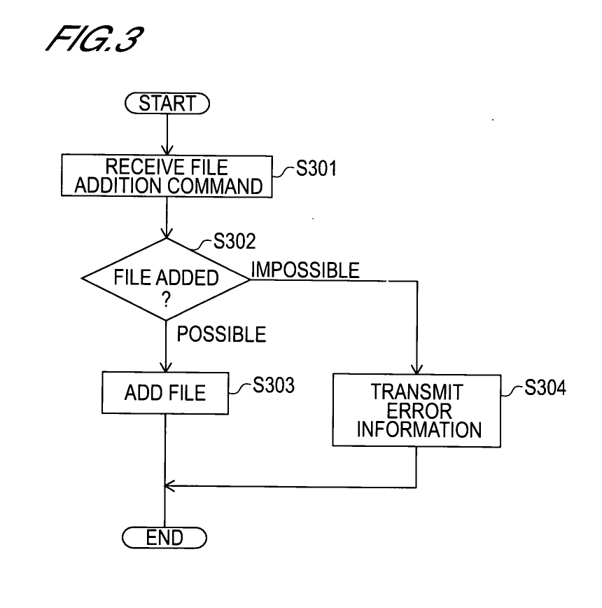

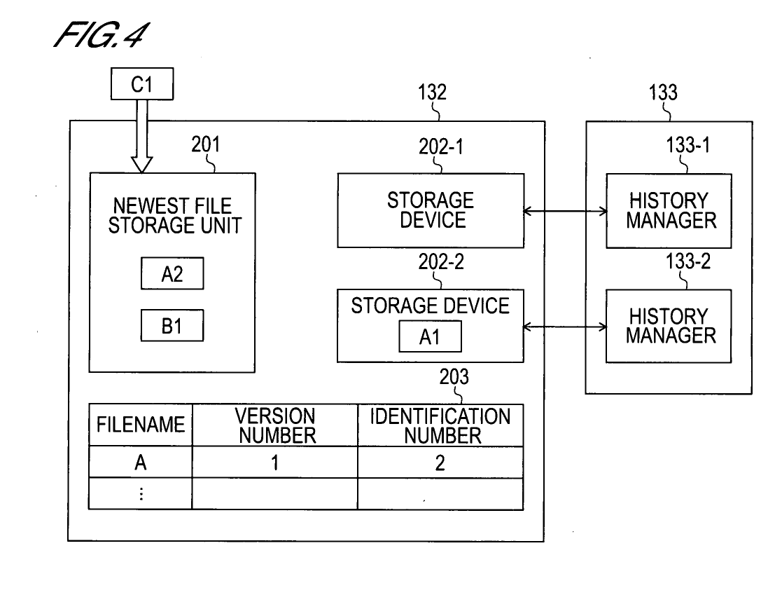

First, operation of the system 100 at the time of registration of new content files is explained, using FIG. 3 and FIG. 4. FIG. 3 is a flowchart used to explain operation of the version management tool 130; FIG. 4 is a conceptual diagram used to explain operation of the version management tool 130.

As shown in FIG. 4, content A, which has already had one version upgrade, and content B, which has not yet had a version upgrade, are registered in the version management tool 130. With respect to content A, content file A1 of the first version is stored in the storage device 202-2 of the non-newest file storage unit 202 (not shown in FIG. 4), and the newest-version content file A2 is stored in the newest file storage unit 201. With respect to content B, the first-version content file B1 is stored in the newest file storage unit 201. In the revision management table 203 is recorded management information relating to the content file A1 stored in the non-newest file storage unit 202, that is, the filename “A”, version number “1”, and storage device identification number 2.

When a user wishes to register new content C, that is, a content file C1, he operates the client terminal 120 (see FIG. 1) and transmits to the version management tool 130 a file addition command for the content file C1. This command is received by the control unit 131 via the network 110 and communication unit 134 (see step S301 of FIG. 3).

The control unit 131 judges whether the content file C1 can be added, based on the filename, file size, and other information contained in the file addition command (see step S302 of FIG. 3).

When it is judged that the content file C1 can be added, the control unit 131 stores this content file C1 in the newest file storage unit 201 (step S303 in FIG. 3), and ends registration processing. The content file C1 is the first-version file of the content C, and so content file transfer from the newest file storage unit 201 to the non-newest file storage unit 202, and addition of management information to the revision management table 203, are not performed.

When it is judged in step S302 that the content file C1 cannot be added, the control unit 131 transmits error information indicating this judgment result to the client terminal 120 (step S304 in FIG. 3), and ends registration processing. Addition of the content file C1 may be judged impossible when, for example, a content file with filename C1 is already stored, or when the file size of the content file C1 is too large, so that there is concern that overflow of the version management tool 130 may occur.

Content Version Upgrades

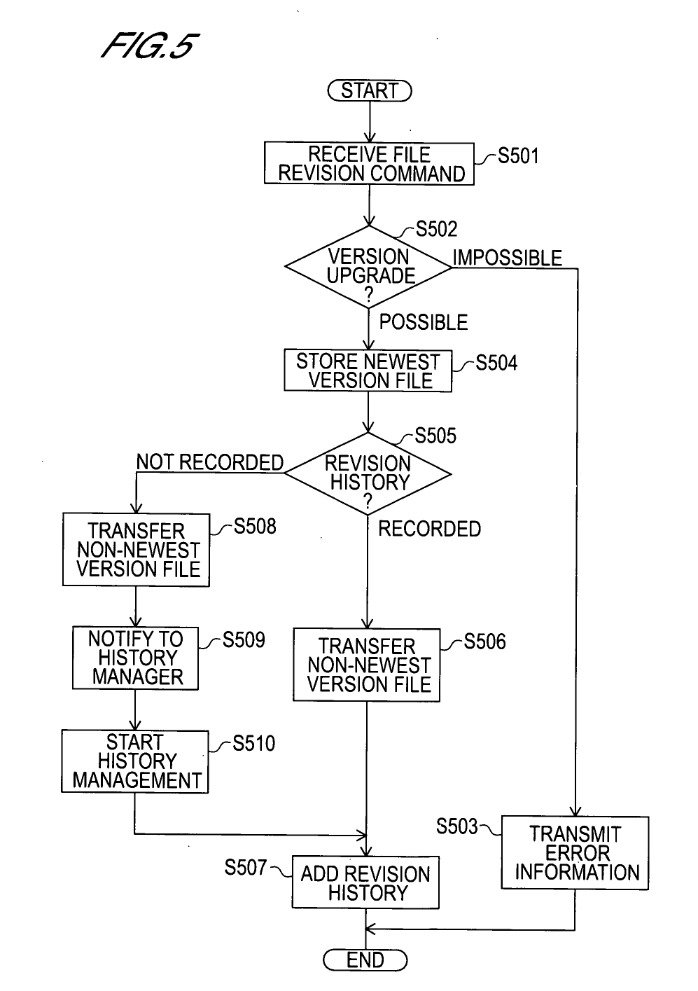

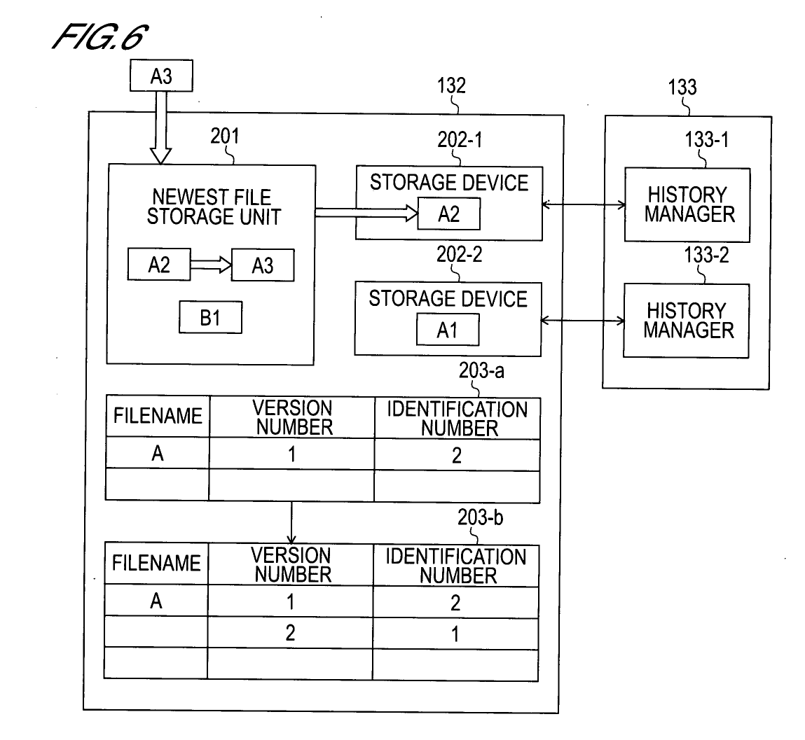

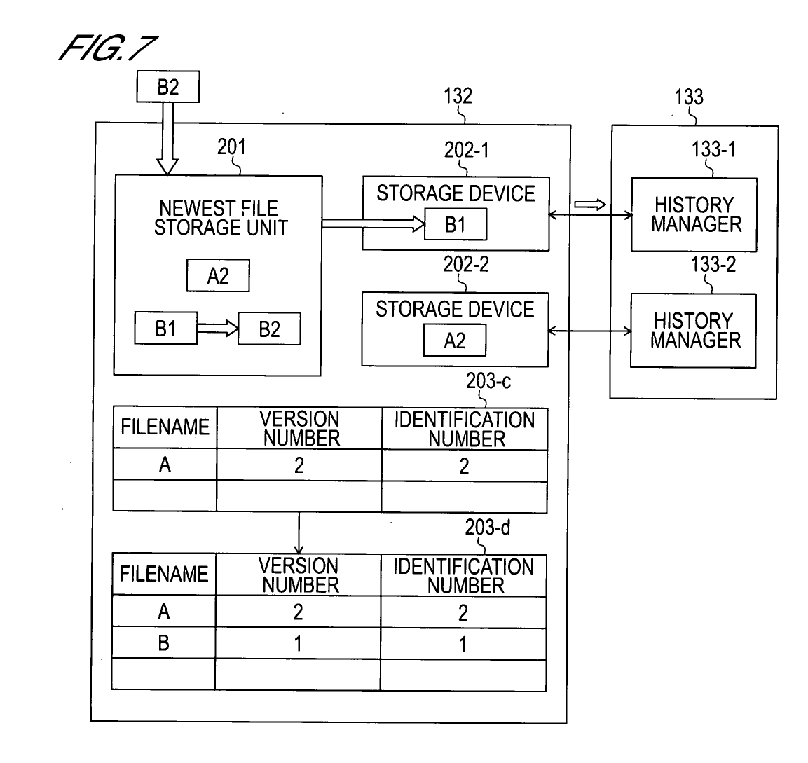

Next, operation of the version management tool 130 when a registered content undergoes the version upgrade is explained using the flowchart of FIG. 5 and the conceptual diagrams of FIG. 6 and FIG. 7.

In the example of FIG. 6, similarly to the example of FIG. 3, content A which has already undergone one version upgrade, and content B which has not yet undergone a version upgrade, are registered. Content file A1 is stored in storage device 202-2, and content files A2 and B1 are stored in the newest file storage unit 201. Management information relating to the content file A1 stored in the non-newest file storage unit 202 (not shown in FIG. 6) is recorded in the revision management table 203. In the example of FIG. 6, content A undergoes a version upgrade; in the example of FIG. 7, content B undergoes a version upgrade.

First, operation of the version management tool 130 when content A undergoes the version upgrade is explained using FIG. 5 and FIG. 6.

When the user wishes to subject content A to a version upgrade, that is, when he wants to register a content file A3, he operates the client terminal 120 (see FIG. 1) to transmit a file revision command for content A to the version management tool 130. This command is received by the control unit 131 via the network 110 and communication unit 134 (step S501 in FIG. 5).

The control unit 131 (see FIG. 1) judges whether content A can be version-upgraded, based on filename and other information contained in the file revision command (step S502 in FIG. 5).

When version upgrading of content A is not possible, the control unit 131 transmits error information indicating this judgment result to the client terminal 120 (step S503 in FIG. 5), and ends version upgrade processing. For example, when a file for content A is not stored in the newest file storage unit 201, or when a content file with filename A3 is already stored, version upgrading of content A is judged to be impossible.

When on the other hand version upgrading is judged to be possible in step S502, the control unit 131 receives the content file A3 from the client terminal 120. The control unit 131 then stores the content file A3 in the newest file storage unit 201 (step S504 in FIG. 5).

Next, the control unit 131 judges whether history for content A is recorded in the revision management table 203 (step S505 in FIG. 5). In the example of FIG. 6, content A has already undergone a version upgrade from A1 to A2, so that history relating to content A is recorded in the revision management table 203 (203a in FIG. 6). In this example, content files which became non-newest files due to version upgrades in May 2004 are stored in the storage device 202-2, and content files which became non-newest files due to version upgrades in June 2004 are stored in the storage device 202-1. Hence if the version upgrade from content file A2 to A3 takes place in June 2004, the control unit 131 deletes the content file A2 from the newest file storage unit 201, and transfers the file A2 to store it in the storage device 202-1 (step S506 in FIG. 5). Further, the control unit 131 records the revision history for the content file A2 in the column for content A of the revision management table retrieved in step S505 (step S507 in FIG. 5 and 203b in FIG. 6), and ends version upgrade processing.

When a revision management table 203 is not provided in the content management unit 132, in place of the revision management table 203, history for content A is retrieved from all the history managers 133-1, 133-2, . . . in step S505.

Next, operation of the version management tool 130 in the event of a version upgrade of content B from B1 to B2 is explained, using FIG. 5 and FIG. 7.

In the example of FIG. 7, the operation of steps S501 to S505 is the same as in the example of FIG. 6. That is, the user operates the client terminal 120 (FIG. 1) to transmit a file revision command for content B to the version management tool 130 (step S501 in FIG. 5). The control unit 131 (FIG. 1) judges whether version upgrading of content B is possible, based on the filename and other information contained in the file revision command (step S502 of FIG. 5). When version upgrading of content B is not possible, the control unit 131 transmits error information to the client terminal 120 (step S503 in FIG. 5), and ends version upgrade processing. If however it is judged in step S502 that version upgrading is possible, the control unit 131 receives the content file B2 from the client terminal 120. The control unit 131 stores the content file B2 in the newest file storage unit 201. Next, the control unit 131 judges whether history for content A is recorded in the revision management table 203 (step S505 in FIG. 5). In the example of FIG. 7, content B has not undergone a version upgrade in the past, so that history relating to content B is not recorded (203c in FIG. 7).

Next, the control unit 131 deletes content file B1 from the newest file storage unit 201, and transfers the file B1 to store it in the storage device 202-1 (step S508 in FIG. 5). Then the control unit 131 notifies the history manager 133-1 of storage of content file B1 in the storage device 202-1 (step S509 in FIG. 5). As a result, history management for content B is started by history manger 133-1 (step S510 in FIG. 5).

Thereafter, the control unit 131 records the revision history relating to content file B1 in the revision management table 203 (step S507 in FIG. 5 and 203d in FIG. 7), and ends version upgrade processing.

Discarding of Content Files for which the Holding Period has Ended

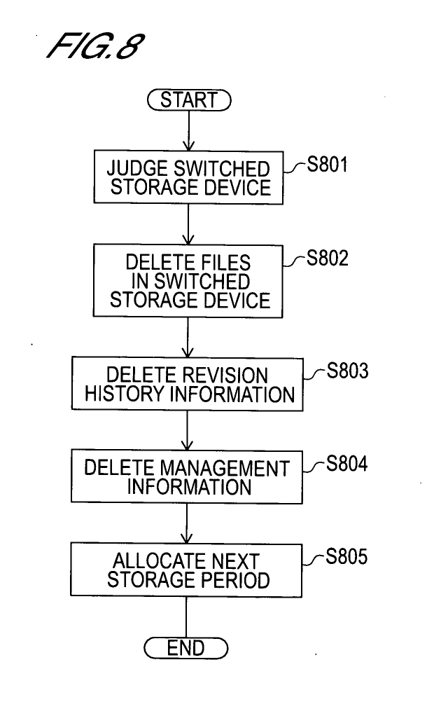

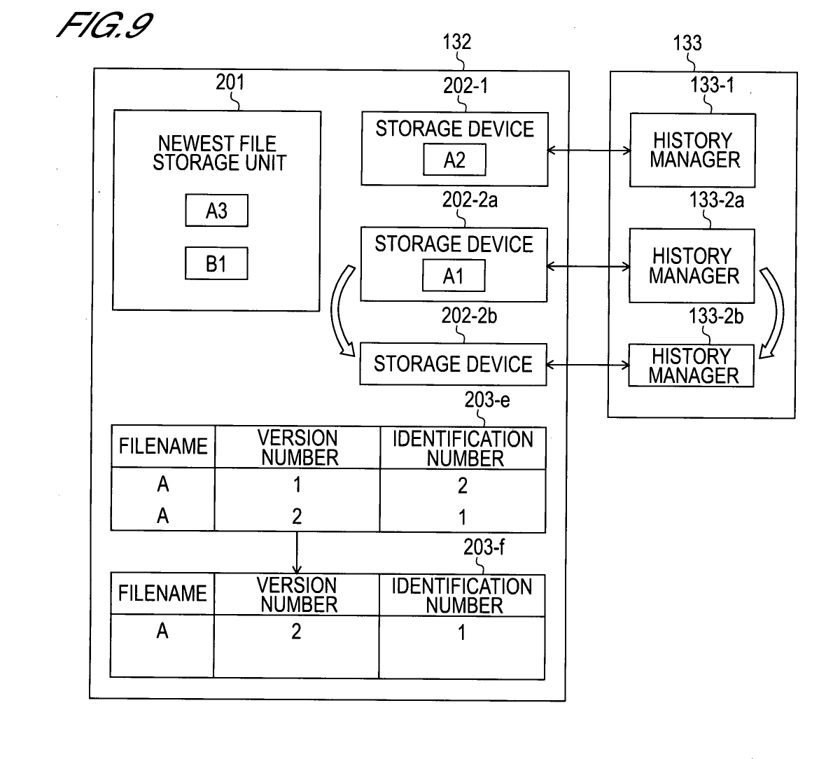

Next, operation of the version management tool 130 in the event of discarding content files the holding period of which has ended is explained, using the flowchart of FIG. 8 and conceptual diagram of FIG. 9.

In the example of FIG. 9, content A, which has already undergone two version upgrades, and content B, which has not yet undergone a version upgrade, are registered in the version management tool 130. With respect to content A, the first-version content file A1 is stored in the storage device 202-2 (202-2a in FIG. 9) in the non-newest file storage unit 202 (not shown in FIG. 9), the second-version content file A2 is stored in the storage device 202-1, and the newest-version content file A3 is stored in the newest file storage unit 201. With respect to content B, the first-version content file B1 is stored in the newest file storage unit 201. Management information relating to content files A1 and A2 stored in the non-newest file storage unit 202, that is, the filenames “A”, version numbers “1” and “2”, and storage device identification numbers “1” and “2”, is stored in the revision management table 203 (203e in FIG. 9).

In the example of FIG. 9, the non-newest file storage unit 202 comprises two storage devices 202-1, 202-2. The periods corresponding to each of the storage devices 202-1, 202-2 are one month. The storage device 202-2 stores content file A1, which became a non-newest file due to a version upgrade in May 2004; the storage device 202-1 holds content file A2, which became a non-newest file due to a version upgrade in June 2004. At the end of the last day in June 2004, the control unit 131 deletes all the files held in storage device 202-2 (in the example of FIG. 9, the single content file A1), and deletes the history information in the history manager 133-2 (202-2b, 133-2b in FIG. 9). By this means, the storage device 202-2 can be used to save content files which have become non-newest files due to version upgrades in July 2004.

Below, the procedure for deletion is explained using FIG. 8.

Storage device switching timing is recorded in the control unit 131 (FIG. 1) in advance. In the present embodiment, the storage device switching timing is the end of the last day of each month. When the control unit 131 judges that the switching timing has been reached, the storage device with the oldest corresponding period is selected from among all the storage devices (step S801 in FIG. 8). In the example of FIG. 9, the storage device 202-1 corresponds to June 2004, and the storage device 202-2 corresponds to May 2004, so that the storage device with the oldest corresponding period is 202-2.

Next, the control unit 131 deletes all the files stored in the storage device 202-2 (step S802 in FIG. 8). As a result, content file A1 is detected from storage device 202-2.

The control unit 131 deletes all the revision history information stored in the history manager 133-2 corresponding to the storage device 202-2 (step S803 in FIG. 8, 133-2b in FIG. 9). As a result, revision history information relating to content file A1 is deleted from the history manager 133-1.

The control unit 131 deletes all the management information for which the storage device identification number is “2” from the management information recorded in the revision management table 203 (step S804 of FIG. 8). As a result, management information relating to content file A1 (203e in FIG. 9) is deleted from the recorded information of the revision management table 203 (203f in FIG. 9).

Finally, the control unit 131 allocates the next storage period to the storage device 202-2 (step S805 in FIG. 8), and ends file deletion processing. In the example of FIG. 9, “July 2004” is newly allocated to the storage device 202-2. As a result, content files which have become non-newest files due to version upgrades performed in July 2004 are stored in the storage device 202-2.

Viewing Non-Newest Version Files

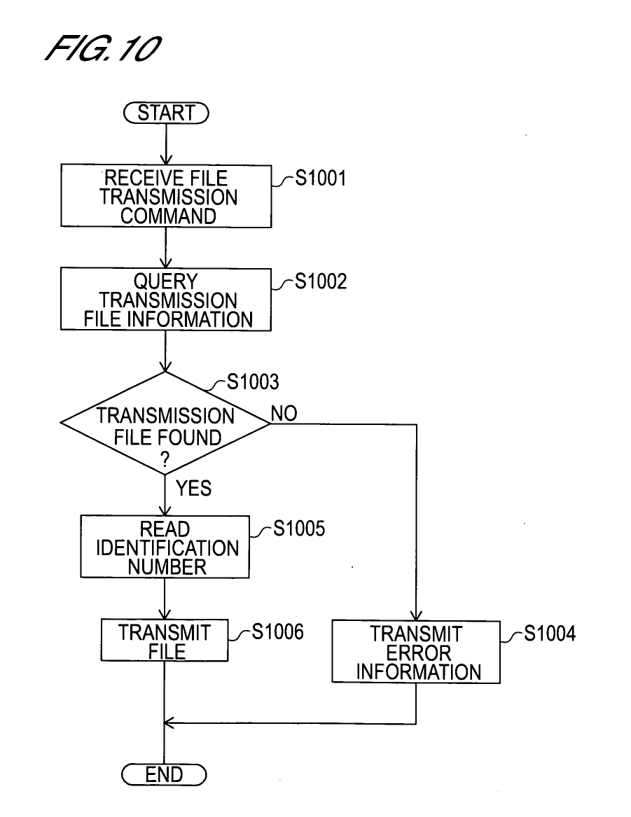

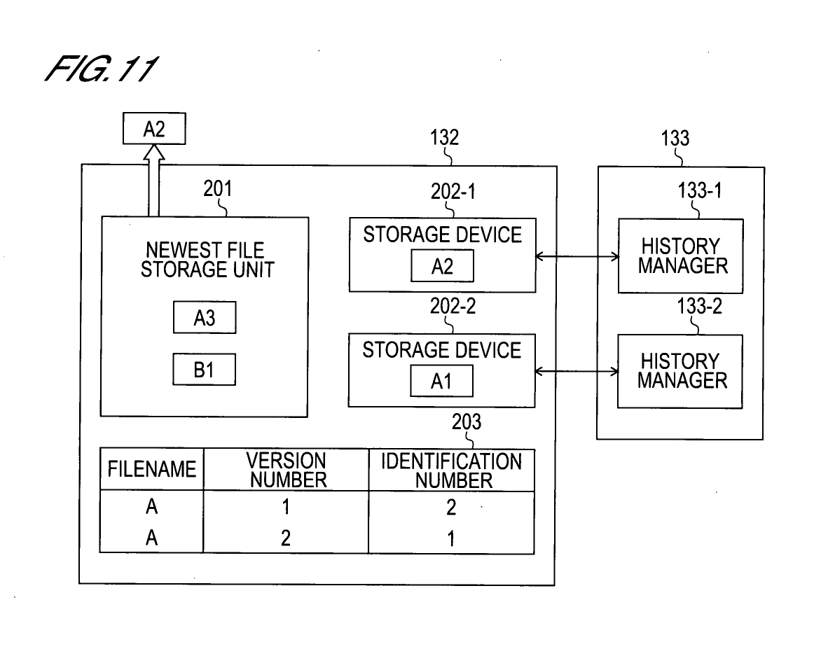

Next, operation of the version management tool 130 when the user views non-newest version content files is explained, using the flowchart of FIG. 10 and the conceptual diagram of FIG. 11.

In the example of FIG. 11, similarly to that of FIG. 9, content A, which has already undergone two version upgrades, and content B, which has not yet undergone a version upgrade, are registered in the version management tool 130.

When a user wishes to view non-newest version content files (in the example of FIG. 11, content file A2), he operates the client terminal 120 (FIG. 1) to transmits a file transmission command to the version management tool 130. This command is received by the control unit 131 via the network 110 and communication unit 134 (step S1001 in FIG. 10).

The control unit 131, upon receiving the file transmission command, queries the client terminal 120 for information on the file for transmission. As a result, the filename and version (in the example of FIG. 11, “A” and “2”) for the file to be transmitted are acquired by the control unit 131 (step S1002 in FIG. 10).

Next, the control unit 131 retrieves the acquired filename and version from the revision management table 203 (S1003). If the relevant content file does not exist, error information indicating this search result is transmitted to the client terminal 120 (step S1004 in FIG. 10), and viewing processing is ended.

When the content file A2 is retrieved in step S1003, the storage device identification number (that is, in the example of FIG. 11, “1”) corresponds the content file A2 is read from the revision management table 203. The control unit 131 reads the content file A2 from the storage device 202-1 corresponding to the storage device identification number “1” thus read (step S1005 in FIG. 10).

The control unit 131 then transmits the content file A2 to the client terminal 120 (step S1006 in FIG. 10), and ends file viewing processing.

Deletion of Content Files by a User

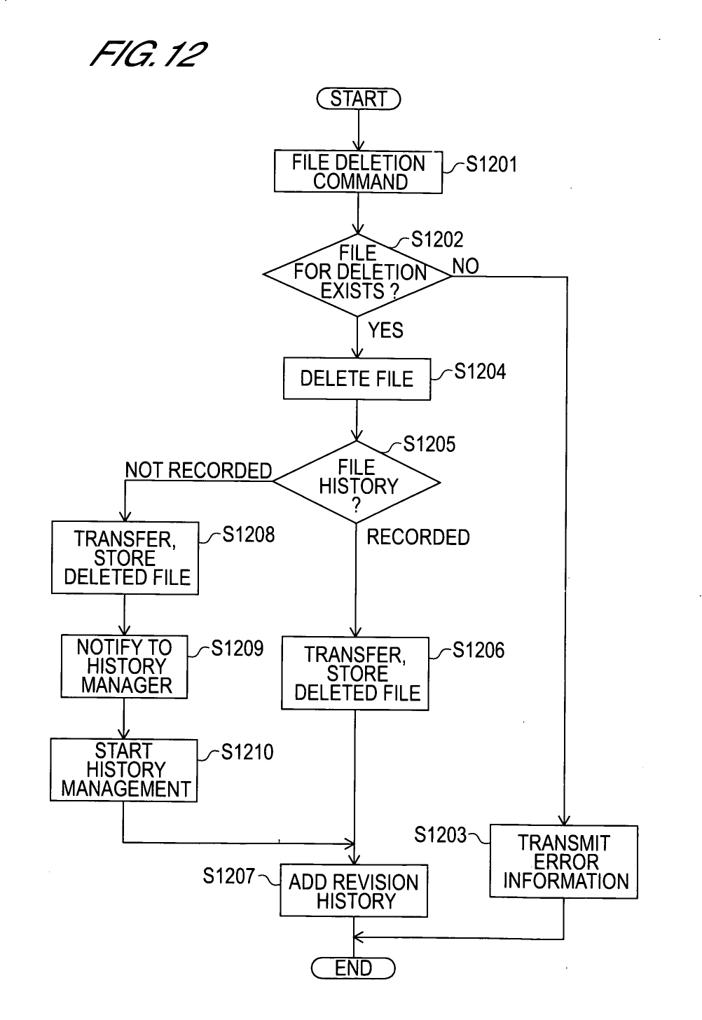

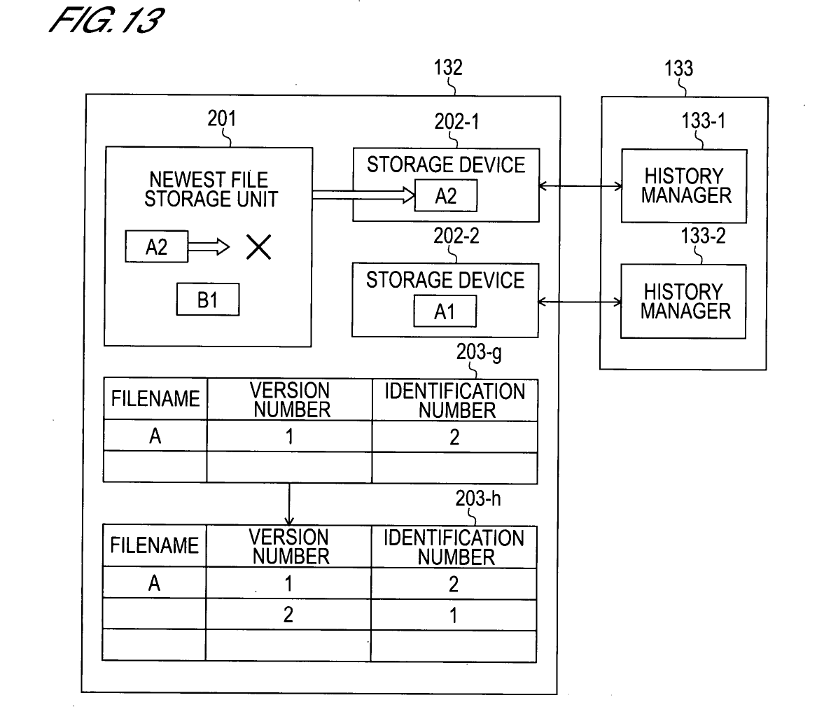

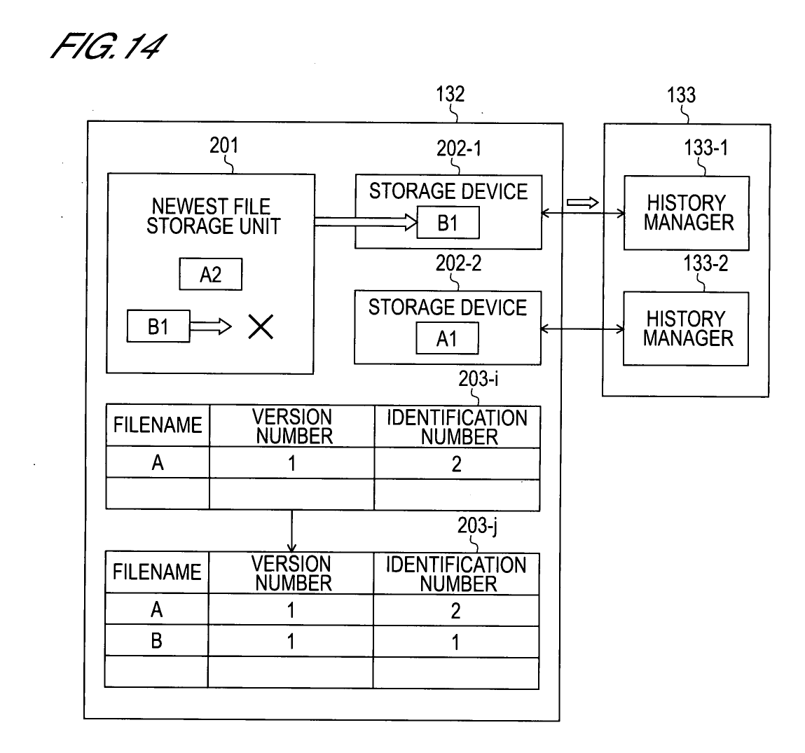

Next, operation of the version management tool 130 when a user deletes content files is explained, using the flowchart of FIG. 12 and conceptual diagrams of FIG. 13 and FIG. 14.

In the example of FIG. 13 and FIG. 14, content A, which has already undergone one version upgrade, and content B, which has not yet been version-upgraded, are registered in the version management tool 130. With respect to content A, the first-version content file A1 is stored in the storage device 202-2 within the non-newest file storage unit 202 (not shown in FIG. 13 and FIG. 14), and the newest-version content file A2 is stored in the newest file storage unit 201. With respect to content B, the first-version content file B1 is stored in the newest file storage unit 201. Management information related to content file A1 stored in the non-newest file storage unit 202, that is, the filename “A”, version number “1” and storage device identification number “2”, are stored in the revision management table 203.

First, processing in the case of deletion of content file A2 by the user is explained using FIG. 12 and FIG. 13.

When the user wishes to delete content file A2, he operates the client terminal 120 (FIG. 1) to transmit a file deletion command to the version management tool 130. This command is received by the control unit 131 via the network 110 and communication unit 134 (step S1201 in FIG. 12).

The control unit 131 judges the filename and version number of the file for deletion (in the example of FIG. 13, “A” and “2”) based on the received file deletion command. The control unit 131 then checks whether the content file in question is stored in the newest file storage unit 201 (step S1202 in FIG. 12). If the relevant content file does not exist in the newest file storage unit 201, error information indicating the check result is transmitted to the client terminal 120 (step S1203 in FIG. 12), and deletion processing is ended.

If in step S1202 the content file is found, the control unit 131 reads the content file, and then deletes the file from the newest file storage unit 201 (step S1204 in FIG. 12). In the example of FIG. 13, the content file A2 is deleted.

Next, the control unit 131 judges whether the history of content A is recorded in the revision management table 203 (step S1205 in FIG. 12). In the example of FIG. 13, content A has been version-upgraded from A1 to A2, so that history relating to content A is recorded in the revision management table 203 (203g in FIG. 13).

The control unit 131 transfers the content file A2 read in the above step S1204 to the storage device 202-1, where it is stored (step S1206 in FIG. 12).

Further, the control unit 131 records the revision history relating to content file A2 in the column of content A in the revision management table 203 (step S1207 in FIG. 12 and 203h in FIG. 13), and ends deletion processing.

Thus in the present embodiment, the content file A2 deleted through user operation is stored in the non-newest file storage unit 202.

Next, processing in a case in which content file B1 is deleted by a user is explained, using FIG. 12 and FIG. 14.

In the example of FIG. 14, the operation of steps S1201 to S1205 are the same as in the example of FIG. 13. That is, the user operates the client terminal 120 (FIG. 1) to transmit a file deletion command for content B to the version management tool 130 (step S1201 in FIG. 12). The control unit 131 (FIG. 1) judges whether content file B1 is stored in newest file storage unit 201 (step S1202 in FIG. 12). If the content file B1 is not stored, the control unit 131 transmits error information to the client terminal 120 (step S1203 in FIG. 12), and ends version upgrade processing. If however in step S1202 the content file B1 is stored, the control unit 131 reads content file B1 and then deletes the file (step S1204 in FIG. 12). Next, the control unit 131 judges whether the history of content A is recorded in revision management table 203 (step S1205 in FIG. 12). In the example of FIG. 14, content B has not undergone a version upgrade in the past, and so there is no history relating to content B recorded in the table (203i in FIG. 14).

Next, the control unit 131 transfers the content file B1 read in step S1204 to the storage device 202-1, where it is stored (step S1208 in FIG. 12). The control unit 131 then notifies the history manager 133-1 of storage of content file B1 in storage device 202-1 (step S1209 in FIG. 12). As a result, history management for content B is started by the history manager 133-1 (step S1210 in FIG. 12).

Thereafter, the control unit 131 records revision history relating to content file B1 in the revision management table 203 (step S1207 in FIG. 12 and 203j in FIG. 14), and ends deletion processing.

A content file which has been deleted by a user, and which is stored in a storage device, is deleted at the end of the holding period for the storage device, similarly to content files which have become non-newest versions due to a version upgrade.

As described above, the version management tool 130 of the present embodiment allocates storage periods and holding periods to each storage device in advance, stores content files which have become non-newest files due to version upgrades in storage devices to which the storage period corresponding to the version upgrade has been allocated, and delete the content files in a storage device at the time at which the holding period for the storage device has elapsed. The holding period is determined according to, for example, the number of storage devices. A new storage period is allocated to a storage device the content files of which have been deleted. Hence processing by the version management tool 130 to discard old content files need only comprise processing for batch deletion of information within a storage device, processing to overwrite the revision management table and history manager to accompany deletion processing, and processing to allocate a new storage period to a storage device after deletion processing.

In addition, the version management tool 130 of the present embodiment discards old-version content files each time when the holding period of which has passed, so that large amounts of storage are not necessary even if these content files are not converted into differential information. Hence there is no need for processing to restore complete file information from the differential information of old content file in the second, accompanying discarding of oldest content files.

As a result, a version management tool 130 of the present embodiment can discard old content files merely through extremely simple, low-load processing.

1. A version management system for content delivery and management, comprising:
a newest file storage unit, which stores newest-version content files;
a non-newest file storage unit, having a plurality of storage elements each of which receives and stores content files which have become non-newest versions due to version upgrades from said newest version file storage unit; and,
a controller, which allocates a storage period and a holding period to each of said storage elements, transfers content files which have become non-newest versions due to said version upgrades to, and stores said files in, said storage element to which said storage period corresponding to the version upgrade date has been allocated, and deletes all content files in said storage elements at the time at which said corresponding holding period has elapsed.

2. The version management system according to claim 1, wherein said controller is constituted to;
allocate said storage periods consecutively to said storage elements,
store in order content files in all of said storage elements according to said allocated storage periods;
regard said holding period of said storage element to which the oldest storage period has been allocated is ended when said storage periods of all storage elements are ended, and deletes all of said content files stored in the storage element; and,
allocates a new storage period to the storage element after the deletion.

3. The version management system according to claim 1, further comprising a history manager which manages content files held in each of said storage elements.

4. The version management system according to claim 3, wherein said controller is constituted to;
adds revision history information for a content file to said history manager, when the content file is stored in said storage element; and,
deletes revision history information for a content file from said history manager, when the content file is deleted from said storage element.

5. The version management system according to claim 1, further comprising a revision management table for batch management of said storage elements in which each of said non-newest version content file is stored.

6. The version management system according to claim 5, wherein said revision management table records, for each non-newest version content file, management information comprising the filename of the content file, the version number of the content file, and the identification number of said storage element in which the content file is stored.

7. The version management system according to claim 5, wherein said controller is constituted to;
adds management information for a content file to said revision management table, when the content file is stored in said storage element; and,
deletes management information for a content file from said revision management table, when the content file is deleted from said storage element.

8. The version management system according to claim 5, wherein said controller, upon receiving a request for viewing of a non-newest version content file from a client terminal, uses said revision management table to identify said storage element in which the requested content file is stored, reads said requested content file from said identified storage element, and transmits said file to said client terminal.

9. The version management system according to claim 1, wherein said controller, upon receiving a request for deletion of a newest version content file from a client terminal, deletes the content file from said newest version storage unit, and transfers the deleted content file to and stores the file in said storage element to which is allocated said storage period corresponding to the date of deletion.

10. The version management system according to claim 9, wherein said controller deletes the content file stored in said storage element based on the deletion request from the client terminal, at the same time as the deletion of content files that have become non-newest version files due to a version upgrade, when the holding period of the storage element is ended.

11. The version management system according to claim 1, wherein each of said storage elements is either an individual storage device, or is a storage area obtained by dividing the storage area of one or a plurality of storage devices.

12. A version control method for content delivery and management, comprising the steps of:
allocating a storage period and a holding period to each of a plurality of storage elements provided in a non-newest file storage unit;
storing newest version content files in a newest file storage unit;
transferring content files which have become non-newest version files due to a version upgrade from said newest version file storage unit to, and storing said files in, said storage element to which has been allocated said storage period corresponding to the version upgrade date; and,
deleting all the content files in said storage elements at the time said corresponding holding period has elapsed.

13. The version control method according to claim 12, wherein;
said storage periods are allocated consecutively to said storage elements;
content files are stored in order in all of said storage elements according to said allocated storage periods,
said holding period of said storage element to which the oldest storage period has been allocated is regarded to be ended when said storage periods of all storage elements are ended, and said content files stored in the storage element are all deleted; and,
a new storage period is allocated to the storage element after the deletion.

14. The version control method according to claim 12, further comprising the steps of:
adding revision history information for a content file to a history manager, when the content file is stored in said storage element; and,
deleting revision history information for a content file from said history manager, when the content file is deleted from said storage element.

15. The version control method according to claim 12, further comprising the steps of:
adding management information for a content file to a revision management table, when the content file is stored in said storage element; and,
deleting management information for a content file from said revision management table, when the content file is deleted from said storage element.

16. The version control method according to claim 15, wherein said management information stored in said revision management table comprises the filename of a non-newest version content file, the version number of the content file, and the identification number of said storage element in which the content file is stored.

17. The version control method according to claim 15, further comprising a step, when non-newest version content file viewing is requested by a client terminal, of using said revision management table to identify said storage element in which the requested content file is stored, reading said requested content file from said identified storage element, and transmitting said file to said client terminal.

18. The version control method according to claim 12, further comprising steps, when deletion of a newest version content file is requested by a client terminal, of;
deleting the content file from said newest version storage unit; and,
transferring the deleted content file to and storing the file in said storage element to which has been allocated said storage period corresponding to the date of deletion.

19. The version control method according to claim 18, further comprising a step of deleting a content file stored in said storage element based on the deletion request from the client terminal, at the same time as deletion of content files that have become non-newest version files due to a version upgrade, when the holding period of the storage element is ended.

20. The version control method according to claim 12, wherein each of said storage elements is either an independent storage device, or is a storage area obtained by dividing the storage area of one or a plurality of storage devices.
